(19) United States
(12) Patent Application Publication
(10) Pub. No.: US 2004/0105966 A1
(43) Pub. Date: Jun. 3, 2004

(54) Decalcomania-like member with an anti-slip pattern or image for manufacturing an anti-slip ceramic product and a method for manufacturing such anti-slip product

(76) Inventors: Giuseppe Zambelli, Bologna (IT); Sergio Nardi, Firenze (IT); Ilaria Agostini, Arezzo (IT)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/306,922

(22) Filed: Nov. 29, 2002

(51) Int. Cl. B32B 3/00

(52) U.S. Cl. 428/206

(57) ABSTRACT

An anti-slip pattern or image is applied to an intermediate support to form an anti-slip decalcomania-like pattern or image to be transferred onto a final ceramic support. The ceramic support undergoes a baking procedures to manufacture a ceramic final product, such as a shower base or a bath tube or a tile for florrs, swimming pool borders, saunas. The anti-slip decalcomania-like pattern or image includes at least one layer of a mixture of granule minerals having melting temperature higher than the baking temperature of the final ceramic product, so that the anti-slip pattern or image granules keep their shape during the baking process or final baking process, forming an anti-slip final ceramic product.

### TECHNICAL FIELD

The present invention relates to sanitary ceramic products, like for example the bottom of shower boxes, also known as shower base, bathtubs, hydro massage tubs, and tiles used in environments, which are humid or in constant contact with water and/or vapor, like borders of swimming-pools, saunas, etc.

More in particular, the present invention relates to an decalcomania-like member with an anti-slip pattern or image for manufacturing an anti-slip ceramic product and a method for manufacturing such anti-slip ceramic product.

### BACKGROUND OF THE INVENTION

It is known that the ceramic products currently used, like bathtubs or shower bases, have usually their outer surface painted with white or colored enamel, bright or opaque, which has only chromatic and aesthetic effect.

A particular problem is to prevent the user from the risk to slide dangerously on the wet or humid enamel.

Usually the outer surfaces of the shower base is manufactured with a kind of “wrinkling” or “undulation” in order to create a grip for the feet, also when the shower base is wet or covered with a layer of water. The “wrinkling” or “undulations” have often a particular geometric pattern and can be more or less close to each other in relation to the effect, which is to be obtained.

However, this solution has only reduced, but not eliminated completely, the risk for the user to slide dangerously.

Another solution currently used includes placing footboards, of plastic material or wood, above the shower base, or in particular areas of the bathtub.

It is obvious that such footboards are not shapely and moreover, they can gather remains of shower gel, shampoo, etc., thereunder, which is evidently not hygienic in case of showers, hydro massage tubs and bathtubs used by more persons.

In case of places which are constantly in contact with water or steam, such as the borders of swimming-pools or saunas, or the like, the slipping risk is reduced by using particular tiles whose surface has asperities, made close to each other, not very high, which increase the tile surface roughness.

The asperities are aimed at increasing the friction between the tiles outer surface, usually very wet or covered by water, and the feet, thus reducing the slipping risk; however, the production of such tiles is very difficult with respect to the production of common tiles.

### SUMMARY OF THE INVENTION

The object of the present invention is to remedies the above mentioned drawbacks and to eliminate completely the slipping risk in case of ceramic products for sanitary use, such as shower bases, bathtubs, or hydro massage tubs, etc., as well as in case of tiles used for places which are wet or in constant contact with water or vapor, such as the edges of swimming-pools, saunas, etc.

More in particular, the main object of the present invention is to propose an anti-slip decalcomania and a method for producing sanitary ceramic products and/or tiles with anti-slip decalcomania.

Another object of the present invention is to propose a method, which is extremely simple and effective, and which eliminates completely, in case of production sanitary ceramic products, as well as tiles, any slipping risk.

A further object of the present invention is to propose a method, with which anti-slip sanitary ceramic articles, and tiles, are produced, which are also shapely and pleasant.

The above mentioned objects are obtained, in accordance with the claims, by a decalcomania-like member with anti-slip pattern or images applied to an intermediate support and forming on said support a raised pattern or an image to be transferred onto a final support, the final support being a ceramic support obtained by baking process, said raised pattern or an image including at least one layer of a mixture of minerals in granules having melting temperature higher than the baking temperature of said final support, so that said anti-slip pattern or images, when applied to the support before baking or final baking, maintains unchanged the shape of the granules at the end of the said baking or final baking.

To manufacture the ceramic product in accordance with the invention, a method is used including:

preparing a raw ceramic support;

drying and engobing the ceramic support;

applying of a glazed or enameled layer to the support and drying said layer;

applying of an emulsion for decalcomania application, in a portions of an outer surface of said ceramic support;

removing an anti-slip pattern or image from the intermediate support and subsequently applying the anti-slip pattern or image to said portions covered with the emulsion;

introducing the ceramic support into a kiln for baking and obtaining a ceramic product or tile;

baking the ceramic product or tile and, due to baking, forming a glazed or enameled coating on the ceramic product or tile and, at the same time, bonding of the anti-slip pattern or image to the ceramic product or tile, the anti-slip pattern or image maintaining the shape of the granules so as to give an anti-slip effect to said portion of the ceramic product or tile.

Another embodiment of the method includes:

applying of said decalcomania to portions of an outer surface of said baked ceramic support and/or tile,

introduction of the baked ceramic support and/or tile with the relative decalcomania into a kiln for baking said support;

baking the ceramic product or tile and, due to baking, forming a glazed or enameled coating on the ceramic product or tile and, at the same time, bonding of the anti-slip pattern or image to the ceramic product or tile, the anti-slip pattern or image maintaining the shape of the granules so as to give an anti-slip effect to said portion of the ceramic product or tile.

According to the invention, a ceramic product is claimed with anti-slip pattern or image formed by an anti-slip decalcomania applied to said ceramic product said anti-slip pattern or image including at least one layer of a mixture of minerals in granules having melting temperature higher than the baking temperature of said final support, so that said anti-slip pattern or image, applied to a ceramic support for producing said ceramic product before baking or final baking, maintains unchanged the shape of the granules at the end of the said baking or final baking.

### BRIEF DESCRIPTION OF THE DRAWINGS

The characteristic features of the present invention will be pointed out in the following description with reference to the enclosed drawings, in which:

FIG. 1a is a schematic top view of a shower base with anti-slip pattern or image obtained according to the proposed method;

FIG. 1b is a schematic top view of tiles with an anti-slip pattern or image obtained according to the proposed method;

FIG. 2 is a schematic top view of possible embodiments of anti-slip decalcomania-like pattern or image;

FIG. 3 is a section view taken along III-III of FIG. 2, in an enlarged scale.

### BEST MODES OF CARRYING OUT THE INVENTION

With reference to the enclosed drawings, the reference numeral 20 indicates the decalcomania-like member with an anti-slip pattern or image, proposed by the present invention.

The anti-slip decalcomania-like member 20 is made from a temporary support 10, which is usually made of special paper known as “gummed paper”, on which raised pattern or images 11, 12, 13, 14,15 are made for being later on transferred, by a decalcomania-like process, to a final support 1, in particular on portions of the outer surface of the latter.

The final support 1 is ceramic and thus destined to be subjected, during various steps of its production, to one or more baking operations, known as respectively single-fired or double-fired baking.

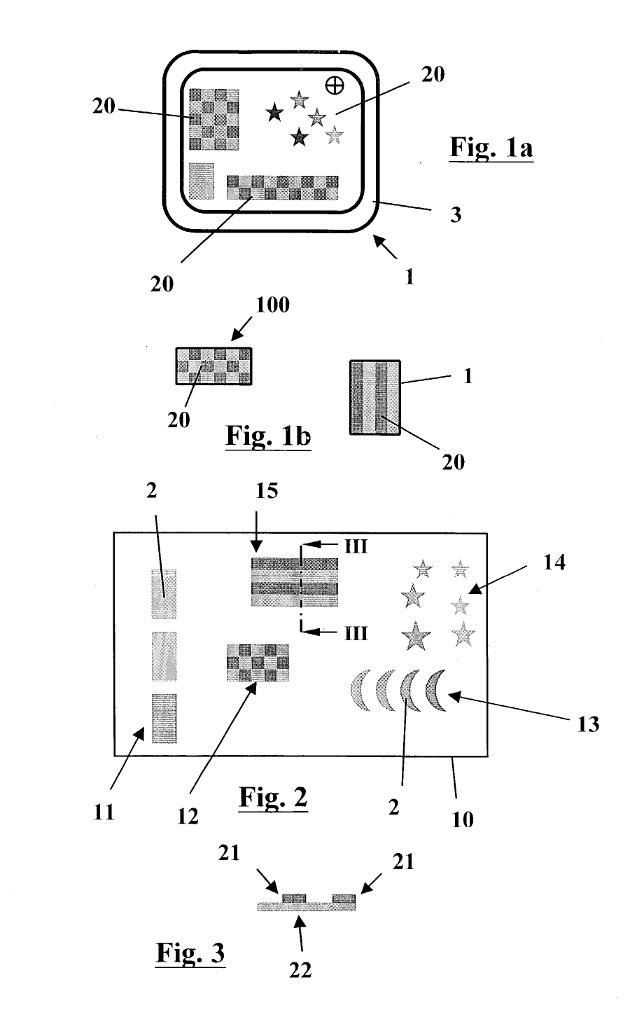

The final support 1 can be e.g. a sanitary ceramic product, such as shower base (as indicated with 3 in FIG. 1a), bathtubs, hydro massage tubs, or a tile (as indicated with reference numeral 100 in FIG. 1b), aimed at being used for obtaining pavements or borders of swimming-pools, saunas, etc.

The anti-slip decalcomania-like member 20 can be applied to the final support 1 before the baking thereof (in case of single-fired process) or in the intermediate phase between the first and second baking (in case of double-fired process).

The raised pattern or images 11, 12, 13, 14,15 of the anti-slip decalcomania-like member 20 includes at least one layer 2 of a mixture of minerals in grains of high fusibility, i.e. minerals whose melting temperature is higher than the temperatures which can be obtained during different steps of baking of the final support 1.

Thus, the pattern or images formed by the layers of minerals can maintain unchanged, or almost unchanged, its granule shape at the end of the baking steps, thus forming an anti-slip pattern or image on the outer surface of the final support 1, which is then glazed as usual or anyway made smooth.

Obviously, the anti-slip effect increases when the surface of the final support 1 is wet.

The minerals present in the mixture are advantageously chosen from those whose hardness is included between 5 and 10 grades in the Mohs scale; this allows to give the anti-slip decalcomania a considerable resistance to scratches, as well as to penetration, maintaining unchanged the anti-slip features.

For instance, in relation to the baking temperatures of the final support 1, the mixture can include either zirconium, or corundum, or alumina, or a mixture of the three minerals.

The percentage of the single minerals present in the mixture will be chosen each time, depending on the case, i.e. according to the type of the final support 1 and to its baking temperature.

The mixture of materials forming the decalcomania print can include, agglomerated with the above mentioned minerals, flux materials, i.e. materials whose melting temperature remains within the range of baking temperature of the final support 1. Therefore, the flux materials facilitate sticking of the decalcomania print to the final support surface.

The quantity of the flux materials to be used will be defined each time by the kind of the final support, on which the pattern or images are to be applied by a decalcomania-like process: in case of soft ceramic materials, or more porous, the percentage of used flux materials will be smaller with respect to the percentage of flux materials used with hard ceramic materials, whose baking temperature is higher.

The above mentioned pattern or images 11, 12, 13, 14, 15 are applied to the intermediate support 10 by silk-screen printing procedure through a screen matrix.

Consequently, the number of granules per surface unit of the print is defined by the weft of the screen used in the silk-screen printing procedure.

The screen filling can be more or less dense, in function to the effect, which is to be given to the anti-slip decalcomania.

The number of threads per surface unit, in cm², of the screen filling can be included between 10 and 120.

The thicker is the weft of the screen, the lower is the number of granules for surface unit of the decalcomania print, and vice-versa, a less thick weft of the screen gives a higher number of granules for surface unit of the decalcomania print, and, anyway, the anti-slip effect is always ensured.

The decalcomania print 21, 22 can have more layers of minerals mixture, possibly agglomerated with flux materials, overlapped and alternated (See FIG. 3).

Each of the layers 21, 22 has a different number of granules for surface unit: the alternating of the layers of mixtures of minerals gives the decalcomania better anti-slip effect, and consequently, bigger adherence of the user's feet, thus eliminating completely the risk of dangerous slipping.

For example, as shown in FIG. 3, a decalcomania print can be equipped with a first lower layer 22, obtained by silk-screen printing procedure through a screen matrix, whose weft is 24 threads per surface unit, in cm², and a plurality of upper layers 21, placed over the first one, obtained by silk-screen printing through a screen matrix, whose weft is 100 threads per surface unit, in cm².

The decalcomania print can not only give an anti-slip effect to the final support, but it can, at the same time, also improve its aesthetic and/or ornamental aspect.

Actually, the decalcomania print can have any figure or geometrical form, artistic and/or patterned, and moreover, it can be made in any color or chromatic contrast.

In point of fact, for this purpose, the mixture of minerals can include (possibly agglomerated with flux materials) coloring chemical compounds used for coloring ceramic products.

The method for obtaining sanitary ceramic products and/or tiles having anti-slip pattern or images proposed by the present invention can be applied in case these ceramic products and tiles are obtained by “single-fired” or “double-fired” process.

In the first case, the method for obtaining sanitary ceramic products and/or tiles having anti-slip pattern or images includes:

preparing a raw ceramic support, drying and engobing the support, applying a glazed or enameled layer and drying thereof,

applying of an emulsion for decalcomania application, in portions of an outer surface of said ceramic support, removing an anti-slip pattern or image from the relative intermediate support and subsequently applying the pattern or image, by a decalcomania-like process, to said portions covered with the emulsion,

introduction of the ceramic support into a kiln for baking the ceramic product or tile, baking of the latter thus forming a glazed or enameled coating of the ceramic product and/or tile and, at the same time, bonding of the anti-slip pattern or image, which maintains unchanged the shape of the granules, so as to give an anti-slip effect in the portions of the outer surface of the ceramic product and/or tile.

The above mentioned emulsion for decalcomania application can be of the kind of “decalfix” paste.

In the second case, the method for obtaining sanitary ceramic products or tiles having anti-slip pattern or images includes:

preparing a raw ceramic support, drying and engobing the support, applying a glazed or enameled layer and drying the added layer, introducing the ceramic product and/or tile into a kiln for baking thereof,

applying the pattern or images to the portions of an outer surface of the baked ceramic product and/or tile, by a decalcomania-like process,

introduction of the baked ceramic product or tile with the decalcomania-like transferred pattern or images into a kiln for baking thereof, baking the latter thus bonding the anti-slip pattern or images, which maintains unchanged the shape of the granules, so as to give an anti-slip effect to the portions of the outer surface of the ceramic product or tile.

It appears obvious from the previous description, how the anti-slip decalcomania-like member proposed by the present invention ensures, in an extremely advantageous way, an anti-slip effect of the ceramic product or tiles, on which it is applied.

In particular, the proposed anti-slip decalcomania ensures appropriate adherence in any conditions, with wet surfaces or in presence of water layers, thus preventing the user from the risk of dangerous slipping.

The proposed method for obtaining sanitary ceramic products and/or tiles having anti-slip decalcomania is extremely simple to carry out in case of products obtained by “single-fired”, as well as by “double-fired” process, giving thereto an innovative anti-slip feature in an extremely advantageous way.

It is understood that what above, has been described as a pure, not limitative example, therefore, possible variants of the steps of the method, in both “single-fired” and “double-fired” process, as well as the number of layers and the shape of the decalcomania print and the materials used, remain within the protective scope of the present technical solution, as described above and claimed hereinafter.

What is claimed is:

1. A decalcomania-like member with anti-slip pattern or images applied to an intermediate support and forming on said support a raised pattern or an image to be transferred onto a final support, the final support being a ceramic support obtained by baking process, said raised pattern or an image including at least one layer of a mixture of minerals in granules having melting temperature higher than the baking temperature of said final support, so that said anti-slip pattern or images, when applied to the support before baking or final baking, maintains unchanged the shape of the granules at the end of the said baking or final baking.

2. A decalcomania-like member according to claim 1, wherein said minerals agglomerated in said mixture are chosen from minerals having hardness included between 5 and 10 grades on Mohs scale.

3. A decalcomania-like member according to claim 2, wherein said mixture of minerals includes one or more minerals chosen among zirconium, corundum, alumina,

4. A decalcomania-like member according to claim 2, wherein said mixture of minerals includes, agglomerated with said minerals, flux materials with melting temperature comprised within the range of baking temperature of the final support, so as to ensure sticking of said anti-slip decalcomania to said final support.

5. A decalcomania-like member according to claim 4, wherein said minerals agglomerated in said mixture are chosen from minerals having hardness included between 5 and 10 grades on Mohs scale.

6. A decalcomania-like member according to claim 4, wherein said mixture of minerals includes one or more minerals chosen among zirconium, corundum, alumina,

7. A method for manufacturing ceramic products or tiles with anti-slip pattern or images, with such anti-slip pattern or images being previously formed by applying a granule mixture of agglomerated minerals to an intermediate support, the method including:
preparing a raw ceramic support;
drying and engobing the ceramic support;
applying of a glazed or enameled layer to the support and drying said layer;
applying of an emulsion for decalcomania application, in a portions of an outer surface of said ceramic support;
removing an anti-slip pattern or image from the intermediate support and subsequently applying the anti-slip pattern or image to said portions covered with the emulsion;
introducing the ceramic support into a kiln for baking and obtaining a ceramic product or tile;
baking the ceramic product or tile and, due to baking, forming a glazed or enameled coating on the ceramic product or tile and, at the same time, bonding of the anti-slip pattern or image to the ceramic product or tile, the anti-slip pattern or image maintaining the shape of the granules so as to give an anti-slip effect to said portion of the ceramic product or tile.

8. A method according to claim 7, wherein said agglomerated minerals in said mixture are chosen from minerals having hardness included between 5 and 10 grades on Mohs scale.

9. A method according to claim 7, wherein said mixture of agglomerated minerals includes one or more minerals chosen among zirconium, corundum, alumina,

10. A method according to claim 7, wherein said mixture of minerals includes, agglomerated with said minerals, flux materials, whose melting temperature remains within the range of baking temperature of the ceramic support, so as to ensure bonding of said anti-slip pattern or image.

11. A method, according to claim 7, wherein said anti-slip pattern or image is transferred to said intermediate support by silk-screen printing procedure through a screen matrix.

12. A method, according to claim 11, wherein the weft of said screen has a number of threads per surface unit, in cm², ranging from 10 to 120.

13. A method, according to claim 7, wherein said anti-slip pattern or image includes more layers of mixtures of agglomerated minerals, overlapped and alternate, each of said layers of minerals being obtained by silk-screen printing procedure through a screen matrix of different weft.

14. A method according to claim 7, wherein said anti-slip pattern or image includes at least one layer of said mixture of agglomerate minerals in granules having melting temperature higher than the baking temperature of said ceramic support, so that said anti-slip pattern or image maintains unchanged the shape of the granules at the end of baking.

15. A method according to claim 14, wherein said agglomerated minerals in said mixture are chosen from minerals having hardness included between 5 and 10 grades on Mohs scale.

16. A method according to claim 14, wherein said mixture of agglomerated minerals includes one or more minerals chosen among zirconium, corundum, alumina,

17. A method according to claim 14, wherein said mixture of minerals includes, agglomerated with said minerals, flux materials, whose melting temperature remains within the range of baking temperature of the ceramic support, so as to ensure bonding of said anti-slip pattern or image.

18. A method, according to claim 14, wherein said anti-slip pattern or image is transferred to said intermediate support by silk-screen printing procedure through a screen matrix.

19. A method, according to claim 18, wherein the weft of said screen has a number of threads per surface unit, in cm², ranging from 10 to 120.

20. A method, according to claim 14, wherein said anti-slip pattern or image includes more layers of mixtures of agglomerated minerals, overlapped and alternate, each of said layers of minerals being obtained by silk-screen printing procedure through a screen matrix of different weft.

21. A method for obtaining sanitary ceramic products and/or tiles with anti-slip decalcomania, includes obtaining of the raw ceramic support, baking and engobing thereof, applying of a glazed or enameled layer and drying said layer, including:
applying of said decalcomania to portions of an outer surface of said baked ceramic support and/or tile,
introduction of the baked ceramic support and/or tile with the relative decalcomania into a kiln for baking said support;
baking the ceramic product or tile and, due to baking, forming a glazed or enameled coating on the ceramic product or tile and, at the same time, bonding of the anti-slip pattern or image to the ceramic product or tile, the anti-slip pattern or image maintaining the shape of the granules so as to give an anti-slip effect to said portion of the ceramic product or tile.

22. A method according to claim 21 wherein said agglomerated minerals in said mixture are chosen from minerals having hardness included between 5 and 10 grades on Mohs scale.

23. A method according to claim 21, wherein said mixture of agglomerated minerals includes one or more minerals chosen among zirconium, corundum, alumina,

24. A method according to claim 21, wherein said mixture of minerals includes, agglomerated with said minerals, flux materials, whose melting temperature remains within the range of baking temperature of the ceramic support, so as to ensure bonding of said anti-slip pattern or image.

25. A method, according to claim 21, wherein said anti-slip pattern or image is transferred to said intermediate support by silk-screen printing procedure through a screen matrix.

26. A method, according to claim 25, wherein the weft of said screen has a number of threads per surface unit, in cm², ranging from 10 to 120.

27. A method according to claim 21, wherein said anti-slip pattern or image includes at least one layer of said mixture of agglomerate minerals in granules having melting temperature higher than the baking temperature of said ceramic support, so that said anti-slip pattern or image maintains unchanged the shape of the granules at the end of baking.

28. A method according to claim 22 wherein said agglomerated minerals in said mixture are chosen from minerals having hardness included between 5 and 10 grades on Mohs scale.

29. A method according to claim 22, wherein said mixture of agglomerated minerals includes one or more minerals chosen among zirconium, corundum, alumina,

30. A method according to claim 22, wherein said mixture of minerals includes, agglomerated with said minerals, flux materials, whose melting temperature remains within the range of baking temperature of the ceramic support, so as to ensure bonding of said anti-slip pattern or image.

31. A method, according to claim 22, wherein said anti-slip pattern or image is transferred to said intermediate support by silk-screen printing procedure through a screen matrix.

32. A method, according to claim 31, wherein the weft of said screen has a number of threads per surface unit, in cm², ranging from 10 to 120.

33. A method, according to claim 22, wherein said anti-slip pattern or image includes more layers of mixtures of agglomerated minerals, overlapped and alternate, each of said layers of minerals being obtained by silk-screen printing procedure through a screen matrix of different weft.

34. A ceramic product with anti-slip pattern or image formed by an anti-slip decalcomania applied to said ceramic product said anti-slip pattern or image including at least one layer of a mixture of minerals in granules having melting temperature higher than the baking temperature of said final support, so that said anti-slip pattern or image, applied to a ceramic support for producing said ceramic product before baking or final baking, maintains unchanged the shape of the granules at the end of the said baking or final baking.

35. A ceramic product according to claim 34, wherein said mixture of minerals includes one or more minerals chosen among zirconium, corundum, alumina,

36. A ceramic product according to claim 34, wherein said product is a shower base.

37. A ceramic product according to claim 34, wherein said product is a a bath tub or a hydro massage tub.

38. A ceramic product according to claim 34, wherein said product is a tile for floors, or for borders of swimming-pools, or for floors of saunas
